(19) United States
(12) Patent Application Publication
(10) Pub. No.: US 2025/0181620 A1
(43) Pub. Date: Jun. 5, 2025

(54) FINE-GRAINED ATTRIBUTION FOR DOCUMENT QUESTION ANSWERING

(71) Applicant: Adobe Inc., San Jose, CA (US)

(72) Inventors: Nedim LIPKA, Campbell, CA (US); Varun MANJUNATHA, Newton, MA (US); Surabhi BHARGAVA, San Jose, CA (US); Sruthi Madapoosi RAVI, San Jose, CA (US); Koustava GOSWAMI, Bengaluru (IN); Joseph BARROW, Alexandria, VA (US); Inderjeet NAIR, Ann Arbor, MI (US); Christopher TENSMEYER, Fulton, MD (US); Balaji Vasan SRINIVASAN, Bengaluru (IN); Ashutosh MEHRA, Noida (IN); Animesh KUMAR, Noida (IN); Ani NENKOVA, Philadelphia, PA (US); Alexa SIU, Sunnyvale, CA (US); Abhilasha SANCHETI, College Park, MD (US)

(73) Assignee: Adobe Inc., San Jose, CA (US)

(21) Appl. No.: 18/528,618

(22) Filed: Dec. 4, 2023

(51) Int. Cl. G06F 16/33; G06F 40/40

(52) U.S. Cl. CPC G06F 16/3344; G06F 40/40

(57) ABSTRACT

Embodiments are disclosed for generating fine-grain attributions for document question answering systems. The method may include receiving a question for a document. An answer generator generates an answer corresponding to the question. An attribution request associated with a portion of the answer is received. The portion of the answer includes a subset of text from the answer. An attribution generator generates one or more attributions for the portion of the answer based on sources associated with the answer. The one or more attributions are then presented for display.

### BACKGROUND

Document Question Answering (DQA) is a machine learning task in which a user asks a natural language question about a document and receives a natural language answer. Typically, a user may provide the document and the question to a DQA model which then processes the question and the document to determine the answer. Various machine learning models may be used for document question answering, such as a pretrained language model (PLM), large language model (LLM), or other model. DQA systems return a natural language answer to the received question. This may take the form of a chat bot, smart assistant, etc.

### SUMMARY

Introduced here are techniques/technologies that generate fine-grain attributions for answers in document question answer (DQA) systems. For example, the DQA system includes an answer generator which implements DQA techniques for generating an answer related to a document. The DQA system also includes an attribution generator which analyzes the document and the answer to determine appropriate attributions. The attributions may include visual references (e.g., like footnotes or endnotes) which point to portions of the document that support the answer. The attributions are fine grain in that they may be made at the sentence or clause level, rather than at the answer level.

In some embodiments, the attribution generator can identify portions of a document that are relevant to portions of the answer. For example, portions of the document and portions of the answer may be encoded to generate corresponding embeddings. Using these embeddings, relevance scores may be calculated. Using these relevance scores, portions of the document are assigned as attributions for the corresponding relevant portions of the answer. Attributions may be determined as part of the answer generation pipeline or may be determined later upon request from a user.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of fine-grained attribution for document question answering in accordance with one or more embodiments;

FIG. 2 illustrates a diagram of a user interface for fine-grained attribution for document question answering in accordance with one or more embodiments;

FIG. 3 illustrates a diagram of a process of self-attribution for document question answering in accordance with one or more embodiments;

FIG. 4 illustrates a diagram of a process of fact check attribution for document question answering in accordance with one or more embodiments;

FIG. 5 illustrates a diagram of a process of retrieval-based attribution for document question answering in accordance with one or more embodiments;

FIG. 6 illustrates an example attribution generator for retrieval-based attribution for document question answering in accordance with one or more embodiments;

FIG. 7 illustrates a schematic diagram of document question answering system in accordance with one or more embodiments;

FIG. 8 illustrates a flowchart of a series of acts in a method of fine-grained attribution for document question answering in accordance with one or more embodiments; and

FIG. 9 illustrates a block diagram of an exemplary computing device in accordance with one or more embodiments.

### DETAILED DESCRIPTION

One or more embodiments of the present disclosure include a document question answering (DQA) system configured to provide fine-grain attribution for answers. Conventional question answering systems often do not provide any supporting documentation (e.g., “attribution”) for their answers. This has led to issues where users may obtain answers without confirming that the answers are accurate. However, DQA systems are not perfect and may make an error when answering a question based on various model limitations (e.g., poor training, hallucination, etc.). In an attempt to address these issues, other conventional systems have attempted to add attribution to the answers produced by the model.

However, these approaches can result in less accurate answers and lead to further confusion. For example, one attribution technique is performed by modifying the prompt that is submitted to the DQA model specifically asking for the model to identify sources for the answer. Such prompt modifications, however, lead to changes to the answer provided by the model, which may reduce accuracy. Additionally, these approaches provide coarse-grain attributions that may refer to an entire document, or multiple documents, as providing support for an entire answer. This may make the answer appear to be well supported, but without finer-grain attributions, the user may not be inclined to determine whether the attribution actually supports the answer.

To address these and other deficiencies in conventional systems, the DQA system of the present disclosure provides fine-grain attributions for answers. For example, embodiments can identify the portion of a document that is relevant to a portion of the answer. This allows for fine-grain citations at the sentence or clause level. This granularity may be configurable by the user. Additionally, embodiments include a configurable pipeline which allows for flexibility for use in different document question answering implementations.

In some embodiments, the DQA system includes an attribution generator which analyzes the document and the answer to determine appropriate attributions. The attribution generator can identify portions of a document that are relevant to portions of the answer. For example, portions of the document and portions of the answer may be encoded to generate corresponding embeddings. Using these embeddings, relevance scores may be calculated. Using these relevance scores, portions of the document are assigned as attributions for the corresponding relevant portions of the answer. This improves trust in the system, and it discourages the user from just blindly accepting the system's answer, since the user can readily crosscheck the citations.

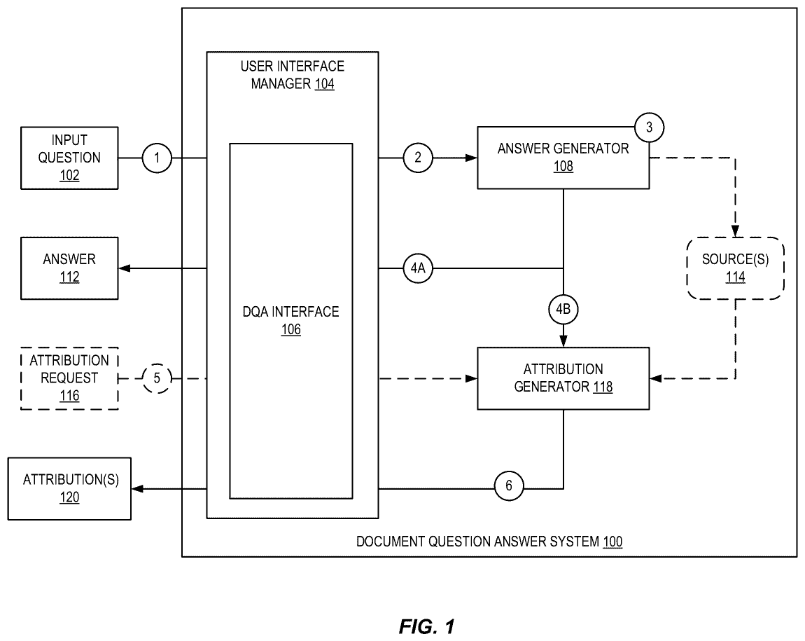

FIG. 1 illustrates a diagram of a process of fine-grained attribution for document question answering in accordance with one or more embodiments. As shown in FIG. 1, a document question answering (DQA) system 100 can receive questions from a user related to a document and provide answers in return. The input question 102 and the answer 112 may both include natural language text. In various embodiments, the DQA system 100 may be implemented as a standalone application or service, or may be incorporated into a document management system. For example, a document management system may be an application or service that facilitates the viewing, creation, and/or editing of documents. In some embodiments, the DQA system may be used with text documents, multimedia documents, or any content that includes text. Although embodiments are discussed generally with respect to document question answering, various embodiments may be used with any task performed on a document that may involve extraction, paraphrasing, or reasoning. Such tasks may include responding to requests like ‘summarize the main points of this document,’ ‘create a table with pros and cons based on this document,’ ‘create an itemized list of the most important points of this document,’ etc.

As shown in FIG. 1, at numeral 1, an input question 102 is received via DQA interface 106. As discussed further below, a user interface manager 104 may facilitate communication of data (e.g., inputs and outputs) through the DQA interface 106 to/from the user and to/from the DQA system. DQA interface 106 may be provided by the DQA system or may represent the user interface provided by a document management system or other application or service in which the DQA system is implemented. In some embodiments, the DQA interface may display one or more documents. The user may select an icon or other user interface element associated with the DQA system to display an interface through which the user can provide the question 102.

At numeral 2, the input question and document(s) are provided to answer generator 108. Answer generator 108 may include a DQA model, such as an LLM or other language model which is configured to receive a natural language query and return a natural language answer. The DQA model may be implemented using one or more neural networks. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

At numeral 3, the answer generator 108 processes the input question 102 and document(s) and generates an answer to the input question. In some embodiments, the answer generator may be a full-text answer generator or a retrieval-based answer generator. A full-text generator receives the entire document along with the question and a prompt instructing the DQA model to generate the answer. If the document text is too large to be included (e.g., it exceeds the token limit associated with the DQA model), then the document text may be broken into chunks and each chunk processed separately to generate intermediate answers. The intermediate answers may then be combined to form a final answer. Alternatively, the answer may be refined as each chunk is processed. For example, in a first iteration, the DQA model is instructed to provide an answer based on the first chunk, then in a second iteration, the DQA model is instructed to refine the answer based on the previous answer and the next chunk, and so on until all chunks have been processed. For retrieval-based answer generators, relevant document chunks may be identified (e.g., based on the content of the question). These relevant document chunks may then be provided to the DQA model, along with the question and a prompt, to generate an answer. If the size of the relevant document chunks is too large, then the relevant chunks may be processed similarly to that described with respect to the full-text answer generator, above.

The answer generator may output the answer and the sources used in the answer, the answer and all available document sources (e.g., the chunks processed by the answer generator), or the answer and only those sources retrieved for answering (e.g., the chunks determined by the answer generator to be relevant to the question). Depending on implementation, the answer 112 may be immediately output, via DQA interface 106, as shown at numeral 4A. Additionally, or alternatively, the answer may also be provided to attribution generator 118, as shown at 4B. Attribution generator 118 is responsible for identifying fine-grain source attributions for all or portions of the answer based at least on the document(s). In some embodiments, the attribution generator 118 may be implemented as part of a self-attribution pipeline and may be responsible for parsing attributions and performing error handling. Alternatively, the attribution generator 118 may be implemented as part of a fact-check attribution pipeline and may be responsible for identifying attributions by performing fact matching on facts extracted from all or part of the answer and all or part of the document(s). Further, in some embodiments, the attribution generator 118 may be implemented as part of a retrieval-based attribution pipeline. In such instances, the attribution generator is responsible for retrieving portions of the document(s) which are relevant to, and supportive of, portions of the answer 112. In some embodiments, the attribution generator 118 may use sources 114 identified by the answer generator to identify relevant portions of the document(s). Because the attribution generator is decoupled from the answer generator, in some embodiments the attribution generator can identify pointers to other/related documents that support the answer(s) generated by the answer generator. For example, the attribution generator may have access to a corpus of documents from which it may draw sources to be used for attribution generation.

In some embodiments, the attribution generator 118 may be invoked on-demand by the user. For example, an attribution request 116 may be received by the attribution generator 118, via DQA interface 106, at numeral 5. For example, the user may select all or a portion (e.g., sentence, clause, etc.) of the answer to request attribution(s) for the selected portion. Additionally, or alternatively, attribution generator 118 may automatically generate fine-grain attributions for an answer when it is generated by answer generator 108. For example, the attribution generator 118 may automatically generate attributions for each sentence of the answer. The attributions 120, generated on-demand or automatically, may be returned at numeral 6 via DQA interface 106.

In some embodiments, the attributions 120 may be added to the answer 112. For example, a reference number (e.g., in the style of a footnote or endnote) may be added to the answer for each annotation. When an annotation is selected it may cause the portion of the answer associated with the annotation to be highlighted or otherwise visually distinguished from the rest of the answer. Additionally, the source material corresponding to the annotation may be similarly highlighted in the document(s). This provides a visual link for the user between the portion of the answer and the supporting portion(s) of the document, making it easy for the user to confirm the generated answer.

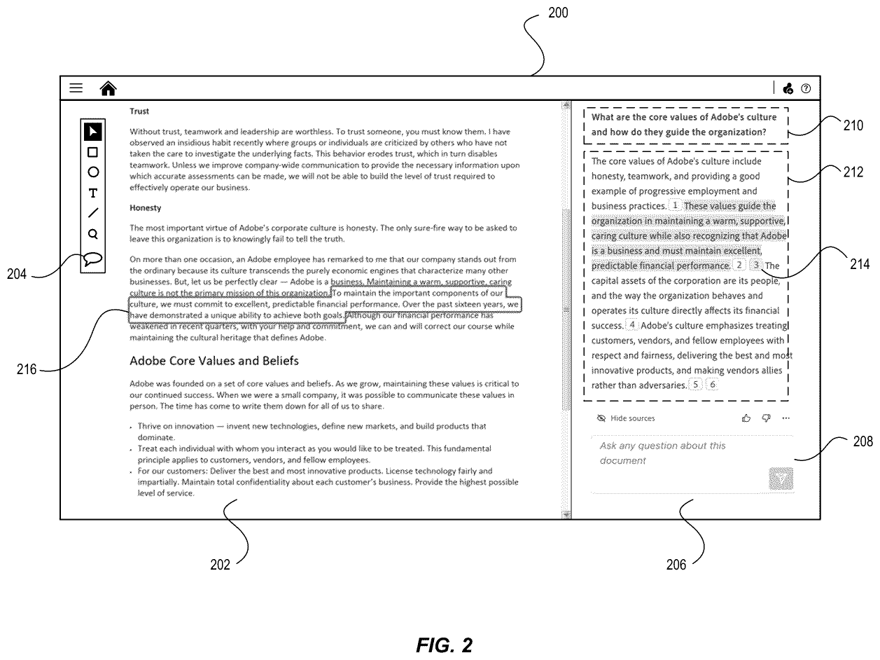

FIG. 2 illustrates a diagram of a user interface 200 for fine-grained attribution for document question answering in accordance with one or more embodiments. As shown in FIG. 2, the user interface 200 may enable a user to view, edit, create, etc. a document 202. Although the example of FIG. 2 shows a single document, in various embodiments multiple documents may be viewed (e.g., in multiple windows, tabs, etc.). In some embodiments, the user may access the DQA system by interacting with the user interface, such as by selecting an icon 204 associated with the DQA system. Although depicted as an icon in FIG. 2, other user interface elements may also be used to access the DQA system.

In some embodiments, when the DQA icon 204 is selected, a DQA interface, such as panel 206 is displayed. The DQA panel can include a UI element for entering a natural language question, such as text box 208. When the user enters a question, it is provided to the DQA system, as discussed, and used along with the open document(s) 202 to answer the question. For example, once the question is entered it may be displayed as shown at 210, followed by the generated answer to the question, as shown at 212. In the example of FIG. 2, attributions for each sentence have automatically been identified and added to the answer, as shown in numbered reference boxes 1-6.

In some embodiments, when a reference box is selected, the corresponding portion(s) of the document 202 may be highlighted. For example, when reference box 3 214 is selected, a passage 216 of document 202 is highlighted. This allows for the user to quickly determine whether the portion of the answer is supported by the passage 216. Additionally, or alternatively, the user may select a portion of the answer (e.g., by tapping a sentence, highlighting a sentence or clause, etc.) and a corresponding passage of the document may be similarly highlighted.

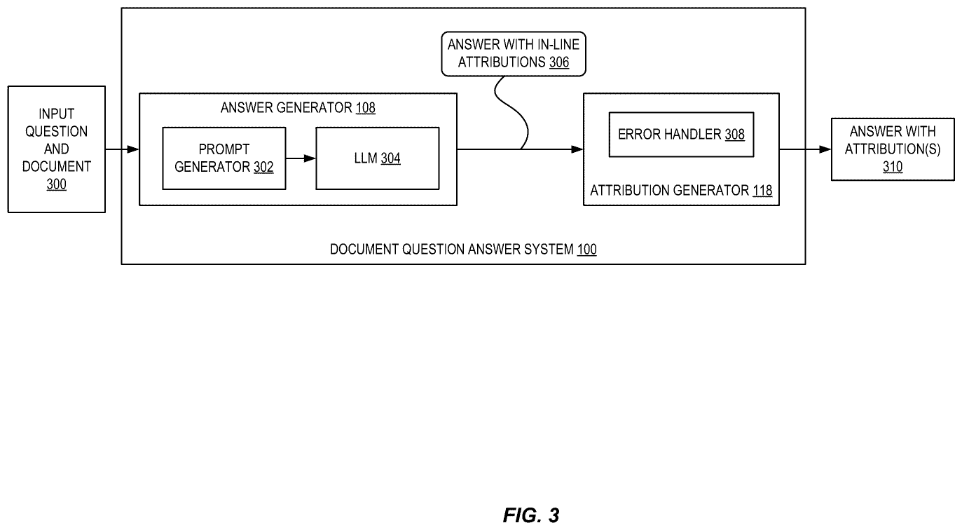

FIG. 3 illustrates a diagram of a process of self-attribution for document question answering in accordance with one or more embodiments. In some embodiments, a DQA pipeline may be used along with self-attribution techniques to identify relevant sources for the answer. In the example of FIG. 3, an input question and document(s) 300 are received by answer generator 108. The answer generator 108 may include a prompt generator 302 and a DQA model, such as LLM 304. The prompt generator 302 may combine the question with a pre-coded, or dynamically generated, prompt which instructs the LLM 304 to answer the question and provide source information at the sentence level.

The output of the answer generator 108 can include the answer with in-line attributions 306. In some embodiments, the answer with in-line attributions 306 can be received by attribution generator 118. The attribution generator 118 can include an error handler 308. The error handler can ensure the in-line attributions are properly formatted for display. For example, a mapping between reference numbers and sources can be maintained and validated by the error handler 308 (e.g., ensure that the sources are formatted correctly). This mapping can be used when a reference number is selected to highlight the correct portion of the document to display the attribution source. For example, the mapping can include pointers that point from a portion of the answer to a location in the document corresponding to the source associated with the attribution.

Self-attribution, as performed in the example of FIG. 3, benefits from high precision. Additionally, it does not add significant processing time, as attribution is performed as part of the answer generation task. However, because it relies on the LLM 304 to identify the sources for the answer, it risks either hallucination by the LLM (e.g., where the LLM makes up a source for the answer that does not exist) or simple return of the document chunks which were given to the LLM. Additionally, use of the LLM for self-attribution can lead to formatting errors, since the output is generated.

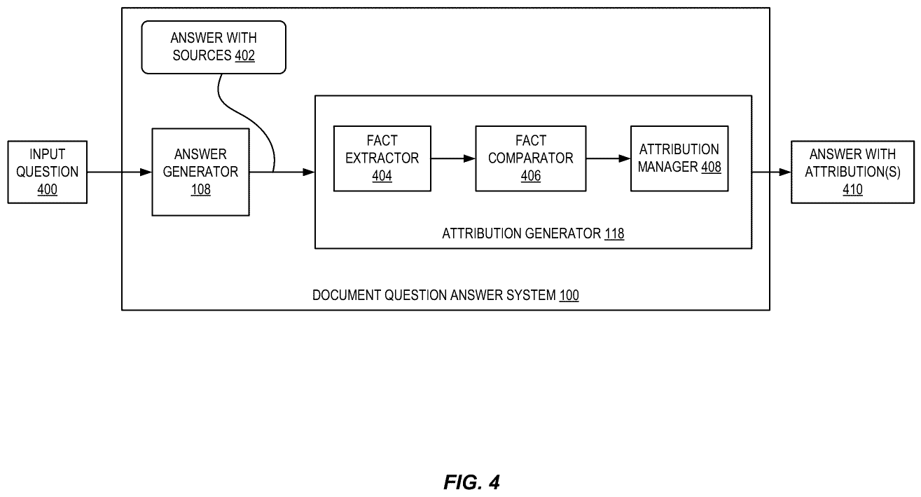

FIG. 4 illustrates a diagram of a process of fact check attribution for document question answering in accordance with one or more embodiments. An alternative to self-attribution is fact check attribution. In fact check attribution, facts are extracted from the answer and from document sentences. These are then compared, and a relevance score is calculated between the facts. The document facts determined to be most relevant (e.g., above a relevance threshold) to a portion of the answer are then determined to be the attribution source for that portion of the answer.

As shown in FIG. 4, an input question 400 is received by answer generator 108. As discussed, the answer generator 108 may include a prompt generator and a DQA model, such as an LLM or other language model. Similar to the example of FIG. 3, the prompt generator generates a prompt instructing the DQA model to answer the input question 400. The prompt may instruct the DQA model to provide sources for each sentence of the answer, provide a list of all sources considered, or provide a list of only those sources used in answering the input question. The sources may include particular portions (e.g., clauses, sentences, sections, or other chunks) of the document. The output of the answer generator 108 is an answer with sources 402 which is provided to attribution generator 118.

As shown in FIG. 4, the attribution generator includes a fact extractor 404, a fact comparator 406, and an attribution manager 408. The fact extractor 404 may implement various techniques to identify facts in text. For example, the fact extractor 404 may perform Named Entity Recognition (NER) to identify entities (e.g., people, places, dates, etc.) referenced in the text and information extraction to identify information about the entities in the text. Other techniques, such as part of speech tagging may also be used, alone or along with NER, information extraction, etc., to extract facts from the document and the answer.

Once facts have been extracted, fact comparator 406 can determine the document facts are relevant to particular answer facts. In some embodiments, the fact comparator 406 may include an encoder which generates an embedding for each of the facts. Each embedding may be a high-dimensional vector that represents the features of the fact. These vectors may be compared by the fact comparator 406 to determine which document facts are relevant to answer facts. For example, cosine similarity may be used to determine the similarity between the embeddings. In some embodiments, a relevance may be determined based on the similarity scores calculated for pairs of document-answer facts. For example, the similarity scores may be normalized to generate relevance scores. The output of the fact comparator can include document-answer fact pairs, each associated with a relevance score.

Attribution manager 408 receives the document-answer fact pairs and relevance scores and generates attributions. For example, the attribution manager 408 may filter out any pairs having a relevance score lower than a threshold value. In some embodiments, there may also be a limit of how many attributions may be provided per answer fact. In such instances, the attribution manager 408 may select the document facts having the highest relevance scores up to the maximum number of attributions for each fact. In some embodiments, the attribution manager 408 may also provide deduplication of attribution candidates. This allows for identical or very similar attributions to be removed. Additionally, or alternatively, the attribution manager 408 can organize attributions. For example, if two consecutive sentences use the same citation, they may be merged into a single citation associated with each sentence. Once relevant facts remain, the attribution manager can generate corresponding attributions and output the answer with corresponding attributions 410. For example, the attribution manager 408 can generate a mapping between attributions to be displayed (e.g., such as the reference numbers described above) and the portions of the document corresponding to the relevant facts. In some embodiments, the mapping is represented using pointers which are associated with each portion of the answer and point to the portion of the document corresponding to the relevant facts. In some embodiments, the attribution manager can perform similar functions to the error handler, described above, to ensure that the sources are formatted correctly. Like the similar mapping described with respect to FIG. 3, this mapping can be used when a reference number is selected to highlight the correct portion of the document to display the attribution source.

Fact check attribution provides a versatile solution that works with a large number of different answer generator implementations. It also provides high precision and high recall. However, the additional fact extraction adds latency and processing costs that reduce overall performance of the solution.

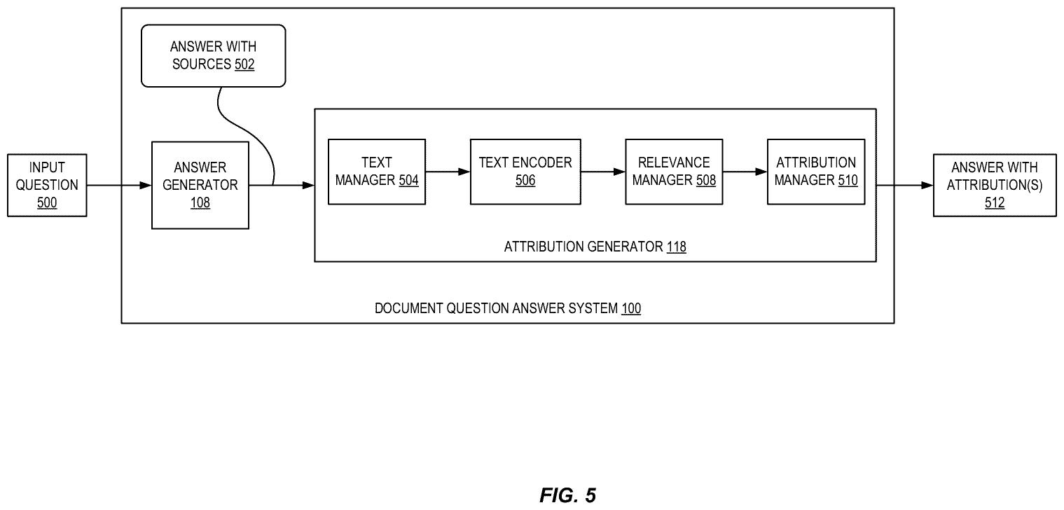

FIG. 5 illustrates a diagram of a process of retrieval-based attribution for document question answering in accordance with one or more embodiments. An alternative to self-attribution and fact-based attribution is retrieval-based attribution. Retrieval-based attribution uses the answer to retrieve document chunks that can serve as attribution sources. Similar to fact-based attribution, relevance scores may be used to identify the document chunks being retrieved. As shown in FIG. 5, an input question is received by answer generator 108. Like in the fact-based implementation described above, the answer generator 108 may include a prompt generator and a DQA model, such as an LLM or other language model. The prompt generator generates a prompt instructing the DQA model to answer the input question 500. The prompt may instruct the DQA model to provide sources for each sentence of the answer, provide a list of all sources considered, or provide a list of only those sources used in answering the input question. The sources may include particular portions (e.g., clauses, sentences, sections, or other chunks) of the document. The output of the answer generator 108 is an answer with sources 502 which is provided to attribution generator 118.

The attribution generator can include a text manager 504. The text manager can receive the answer and sources 502 and divide each into chunks. For example, the text manager 504 may divide each into sentences. Alternatively, the text manager 504 may implement natural language processing techniques to divide each into finer grain portions, such as clauses. The resulting answer and source portions may be passed to text encoder 506. Text encoder 506 may generate embeddings corresponding to each answer portion and source portion. For example, if each is divided into sentences, then the text encoder 506 may generate sentence embeddings. The sentence embeddings represent the features of the answer sentences and source sentences as high dimensional vectors. These embeddings may then be passed to relevance manager 508.

The relevance manager 508 can compare the source sentence embeddings and answer sentence embeddings to identify which are relevant. For example, the embeddings may be compared in embedding space using, e.g., cosine similarity or other vector similarity metric. In some embodiments, a relevance may be determined based on the similarity scores calculated for pairs of document-answer facts. For example, the similarity scores may be normalized to generate relevance scores. The output of the relevance manager 508 can include relevance scores for document-answer sentence pairs and provide them to attribution manager 510 to generate appropriate attributions.

In some embodiments, attribution manager 510 receives the document-answer sentence pairs and relevance scores and generates attributions. For example, the attribution manager 510 may filter out any pairs having a relevance score lower than a threshold value. In some embodiments, there may also be a limit of how many attributions may be provided per answer sentence. In such instances, the attribution manager 510 may select the document sentences having the highest relevance scores up to the maximum number of attributions for each answer sentence. The attribution manager can then generate corresponding attributions for each answer sentence and output the answer with corresponding attributions 512. For example, the attribution manager 510 can generate a mapping between attributions to be displayed (e.g., such as the reference numbers described above) and the portions of the document corresponding to the relevant answer sentences. In some embodiments, the attribution manager can perform similar functions to the error handler, described above, to ensure that the sources are formatted correctly. Like the similar mappings described above, this mapping can be used when a reference number is selected to highlight the correct portion of the document to display the attribution source.

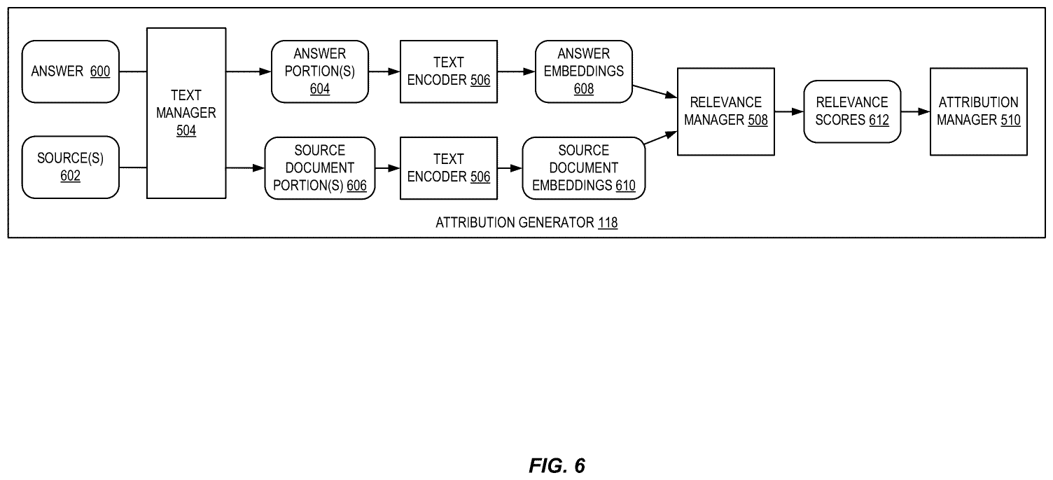

FIG. 6 illustrates an example attribution generator for retrieval-based attribution for document question answering in accordance with one or more embodiments. As discussed, in retrieval-based attribution, the attribution generator 118 can process an answer 600 and source(s) 602 to generate fine-grain attributions for an answer. In some embodiments, the attributions may be generated on demand (e.g., on request for the attributions) or as part of the answer generation pipeline. The text manager 504 can first break the answer 600 and sources 602 into answer portions 604 and source document portions 606. The portions may be clauses, sentences, paragraphs, etc. The portions may also include structured elements like lists, list items, tables, table rows, columns, etc. Additionally, figures can be embedded and retrieved in a similar fashion to textual information. In some embodiments, the size of the portions may be configurable by the user. In some embodiments, the user may select a specific portion of the answer for which to have attributions generated. In such instances, the text manager 504 may only divide the source(s) into source document portions 606.

A text encoder 506 is then used to generate answer embeddings 608 and source document embeddings 610. An answer embedding is generated for each answer portion and a source document embedding is generated for each source document portion. In the example of FIG. 6, two instances of text encoder 506 are used to generate the answer and source document embeddings. These may be copies of the same model, such that the answer embeddings 608 and source document embeddings 610 are generated in the same embedding space. In some embodiments, the same instance of the text encoder 506 may be used to generate all embeddings. A relevance manager 508 can then compare the answer embeddings 608 and source document embeddings 610 to determine relevance scores 612. The relevance scores 612 can be used to identify which source document portions are relevant to which answer portions.

In some embodiments, the attribution manager 510 identifies relevant source document embeddings for a given answer embedding using k-nearest neighbor (KNN) vector retrieval. This identifies the source document embeddings that are “closest” to an answer embedding in embedding space, based on a similarity metric (such as cosine similarity, etc.). In some embodiments, the attribution manager 510 may also use fuzzy string matching to identify relevant source document portions to a given answer portion. To compute relevance scores, embodiments consider the similarities between an answer sentence and document chunks in an embedding space. In an array of evaluations (automatic as well as based on human judgements), a string based fuzzy matching approach is most appropriate in combination with a narrow search scope since the LLM tends to use matching vocabulary during the answer generation. The search scope can be narrowed as described herein.

Additionally, typically, the answer portion and the source document portion are of different lengths. For example, the answer sentence may be fully contained in an attribution candidate. This size difference may lead to a lower relevance score even though the attribution candidate provides direct support for the answer. A windowing technique may be employed to reduce or eliminate this behavior. The windowing technique moves the smaller input step by step over the longer one when computing the similarities and determines the maximum value as the relevance score.

As discussed, the text manager 504 divides the answer 600 and source(s) 602 into answer portion(s) 604 and source document portion(s) 606. In some embodiments, the text manager 504 also removes some words from each portion before computing embedding and relevance scoring. For example, common words such as function words, transitions, articles, etc. may be removed to avoid unnecessarily increasing the relevance score based on matching common words. These may be removed by the text manager 504 before the text is encoded into answer or source embeddings.

In some embodiments, to improve precision, the scope of document chunks considered by the attribution generator can be narrowed. That is, rather than considering the entire document (e.g., all of the document chunks), the search scope may be limited to those sources identified by the answer generator as providing support or as having been retrieved to provide support for the answer. Alternatively, KNN or other retrieval techniques may be used to filter the document chunks to relevant document chunks. In some embodiments, a relevance threshold used to cut off relevance may be adjusted by the user (e.g., via the user interface) or may be fixed by the DQA system. In some embodiments, the relevance threshold can be dynamically determined. With the determined threshold, more document chunks could be retrieved or rejected from larger scopes (other parts of the document, a related document collection, or the Web).

In some embodiments, each answer chunk may be limited to a fixed number of attributions. This fixed number can be a default value or set via the user interface. In some embodiments, a fixed threshold can be used to cutoff retrieved results. The threshold can be selected to set a value that achieves a high precision while preserving a high recall. A fixed value works well due to stripping and windowing which help to keep scores calibrated. For a given answer sentence, embodiments avoid mixing highly relevant and partially relevant attributions. This may be performed by adding a threshold for subsequent attributions. For example, a subsequent attribution may need to be, e.g., 80% as relevant as the first attribution. This subsequent threshold may also be tunable by the user.

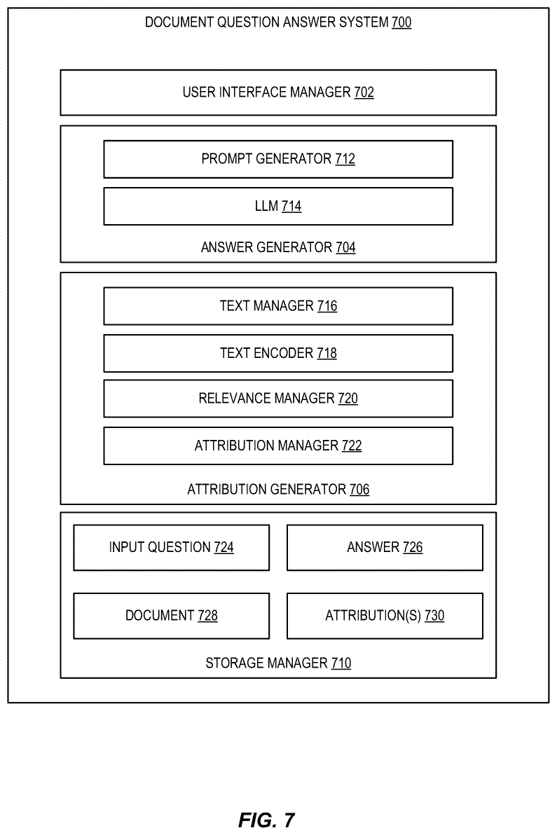

FIG. 7 illustrates a schematic diagram of a document question answering system (DQA) (e.g., “DQA system” described above) in accordance with one or more embodiments. As shown, the DQA system 700 may include, but is not limited to, user interface manager 702, answer generator 704, attribution generator 706, and storage manager 710. The answer generator 704 includes prompt generator 712 and LLM 714. The attribution generator 706 includes text manager 716, text encoder 718, relevance manager 720, and attribution manager 722. The storage manager 710 includes input question 724, answer 726, document 728, and attribution(s) 730.

As illustrated in FIG. 7, the DQA system 700 includes a user interface manager 702. For example, the user interface manager 702 allows users to view, edit create, etc. documents and provide an input question to the DQA system 700. In some embodiments, the user interface manager 702 provides a user interface through which the user can open and view a document 728, as discussed above. The document may be stored in a local or remote storage location accessible using the storage manager 710. In some embodiments, the user interface can further enable the user to provide a natural language question related to the document and receive a natural language answer in response.

As illustrated in FIG. 7, the DQA system 700 includes an answer generator 704. The answer generator 704 can receive the input question 724 and the document 728 and generate an answer in response. In some embodiments, the answer generator may implement DQA techniques to answer the question. For example, the answer generator may include a prompt generator 712 which generates a prompt based on the question 724 and the document 728. The prompt instructs the DQA model, such as LLM 714, to answer the question and optionally provide sources, based on the document, as discussed above.

As illustrated in FIG. 7, the DQA system 700 also includes an attribution generator 706. The attribution generator 706 is responsible for identifying fine-grain attributions for the answer generated by answer generator 704. The attribution generator can be implemented for self-attribution, fact check-based attribution, or retrieval-based attribution, as discussed above. For example, as shown in FIG. 7, in the retrieval-based attribution implementation, the attribution generator can include a text manager 716. The text manager is responsible for dividing the answer and document into chunks which can then be encoded by text encoder 718 into embeddings. The relevance manager 720 can compare the source sentence embeddings and answer sentence embeddings to identify which are relevant. For example, the embeddings may be compared in embedding space using, e.g., cosine similarity or other vector similarity metric. KNN techniques may be used to determine which document embeddings are relevant to which answer embeddings. The output of the relevance manager 720 can include relevance scores for document-answer sentence pairs and provide them to attribution manager 722 to generate appropriate attributions 730.

Various machine learning models (e.g., LLM 714, text encoder 718, etc.) are depicted as being parts of different components of the DQA system 700. However, in some embodiments, a neural network manager may be responsible for hosting a plurality of neural networks or other machine learning models. The neural network manager may include an execution environment, libraries, and/or any other data needed to execute the machine learning models. In some embodiments, the neural network manager may be associated with dedicated software and/or hardware resources to execute the machine learning models. In various embodiments neural networks may be hosted by a single neural network manager or across multiple neural network managers and/or as part of different components.

As illustrated in FIG. 7, the DQA system 700 also includes the storage manager 710. The storage manager 710 maintains data for the DQA system 700. The storage manager 710 can maintain data of any type, size, or kind as necessary to perform the functions of the DQA system 700. The storage manager 710, as shown in FIG. 7, includes the input question 724. The input question 724 can include a natural language text query, as discussed in additional detail above. As further illustrated in FIG. 7, the storage manager 710 also includes answer 726. Answer 726 includes a natural language response to the input question generated by DQA system 700. The storage manager 710 may also include document 728. The document 728 may include any document that includes text content. The storage manager 710 may further include attributions 730. The attributions 730 may correspond to portions of the answer and indicate a corresponding portion of the document that is relevant to that portion of the answer.

Each of the components 702-710 of the DQA system 700 and their corresponding elements (as shown in FIG. 7) may be in communication with one another using any suitable communication technologies. It will be recognized that although components 702-710 and their corresponding elements are shown to be separate in FIG. 7, any of components 702-710 and their corresponding elements may be combined into fewer components, such as into a single facility or module, divided into more components, or configured into different components as may serve a particular embodiment.

The components 702-710 and their corresponding elements can comprise software, hardware, or both. For example, the components 702-710 and their corresponding elements can comprise one or more instructions stored on a computer-readable storage medium and executable by processors of one or more computing devices. When executed by the one or more processors, the computer-executable instructions of the DQA system 700 can cause a client device and/or a server device to perform the methods described herein. Alternatively, the components 702-710 and their corresponding elements can comprise hardware, such as a special purpose processing device to perform a certain function or group of functions. Additionally, the components 702-710 and their corresponding elements can comprise a combination of computer-executable instructions and hardware.

Furthermore, the components 702-710 of the DQA system 700 may, for example, be implemented as one or more stand-alone applications, as one or more modules of an application, as one or more plug-ins, as one or more library functions or functions that may be called by other applications, and/or as a cloud-computing model. Thus, the components 702-710 of the DQA system 700 may be implemented as a stand-alone application, such as a desktop or mobile application. Furthermore, the components 702-710 of the DQA system 700 may be implemented as one or more web-based applications hosted on a remote server. Alternatively, or additionally, the components of the DQA system 700 may be implemented in a suite of mobile device applications or “apps.”

As shown, the DQA system 700 can be implemented as a single system. In other embodiments, the DQA system 700 can be implemented in whole, or in part, across multiple systems. For example, one or more functions of the DQA system 700 can be performed by one or more servers, and one or more functions of the DQA system 700 can be performed by one or more client devices. The one or more servers and/or one or more client devices may generate, store, receive, and transmit any type of data used by the DQA system 700, as described herein.

In one implementation, the one or more client devices can include or implement at least a portion of the DQA system 700. In other implementations, the one or more servers can include or implement at least a portion of the DQA system 700. For instance, the DQA system 700 can include an application running on the one or more servers or a portion of the DQA system 700 can be downloaded from the one or more servers. Additionally or alternatively, the DQA system 700 can include a web hosting application that allows the client device(s) to interact with content hosted at the one or more server(s).

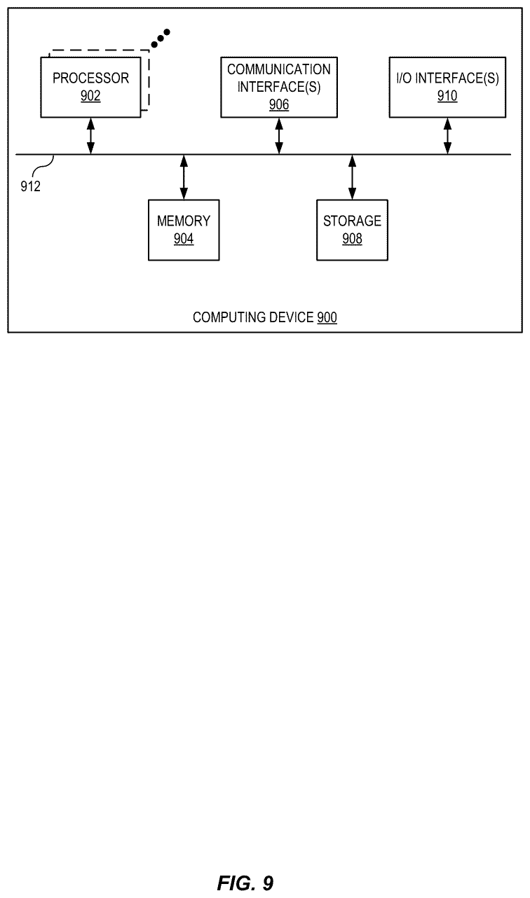

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 9. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 9.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 9.

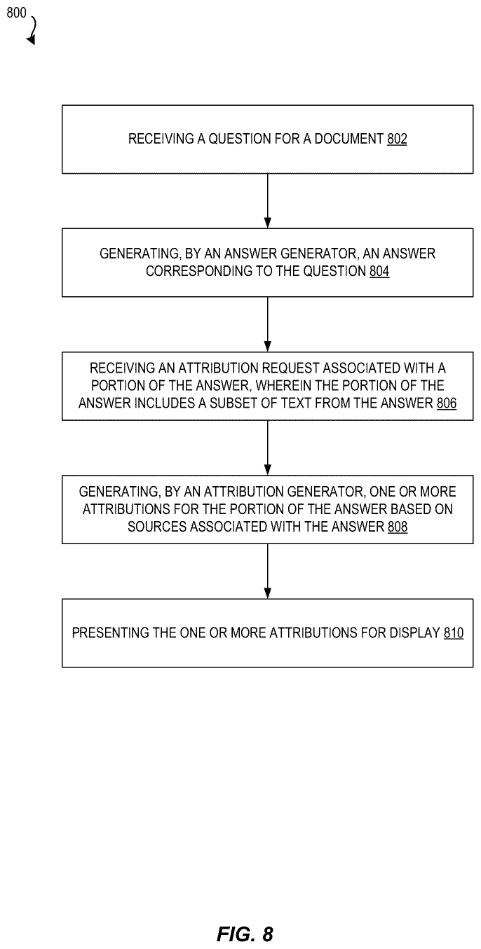

FIGS. 1-7, the corresponding text, and the examples, provide a number of different systems and devices that provide fine-grain attribution for document question answering. In addition to the foregoing, embodiments can also be described in terms of flowcharts comprising acts and steps in a method for accomplishing a particular result. For example, FIG. 8 illustrates a flowchart of an exemplary method in accordance with one or more embodiments. The method described in relation to FIG. 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart 800 of a series of acts in a method of fine-grained attribution for document question answering in accordance with one or more embodiments. In one or more embodiments, the method 800 is performed in a digital medium environment that includes the DQA system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of receiving a question for a document. As discussed, the question may be received via a user interface. For example, the user may select an icon rendered as part of the user interface to access the DQA system. Once selected, a UI element, such as a window, panel, etc. may be displayed with a chat box. The user can ask questions by adding text to the chat box. The resulting answer may also be displayed back to the user via the chat box.

As illustrated in FIG. 8, the method 800 also includes an act 804 of generating, by an answer generator, an answer corresponding to the question. The answer generator implements various DQA techniques to generate an answer to the received question based on the document(s) being viewed. For example, generating, by an answer generator, can include providing, to the answer generator, a prompt including the question, wherein the prompt requests inline source citations from the answer generator, and wherein the inline source citations are parsed for error handling.

As illustrated in FIG. 8, the method 800 also includes an act 806 of receiving an attribution request associated with a portion of the answer, wherein the portion of the answer includes a subset of text from the answer. In some embodiments, attributions may be generated on demand for portions of the answer. For example, the user may select a portion of the answer and be presented with an attribution for that specific portion. Additionally, or alternatively, fine-grain attributions may be generated as the answer is generated and may be displayed on request or may be displayed with the answer, as discussed.

As illustrated in FIG. 8, the method 800 also includes an act 808 of generating, by an attribution generator, one or more attributions for the portion of the answer based on sources associated with the answer. The attribution generator may be implemented as a self-attribution generator, a fact-check based attribution generator, or a retrieval-based attribution generator, as discussed.

In some embodiments, generating, by an attribution generator, one or more attributions for the portion of the answer includes extracting a first one or more fact statements from the portion of the answer, extracting a second one or more fact statements from the sources associated with the answer, and determining the one or more attributions by matching the first one or more fact statements to one or more fact statements from the second one or more fact statements.

In some embodiments, generating, by an attribution generator, one or more attributions for the portion of the answer further includes retrieving, by the attribution generator, one or more portions of the sources based on the portion of the answer, determining, by the attribution generator, a relevance score for each of the one or more portions of the sources, and generating, by the attribution generator, the one or more attributions based on the one or more portions of the sources and their corresponding relevance scores.

In some embodiments, a relevance score for a second attribution is within a relative threshold difference from a relevance score for a first attribution. In some embodiments, the portion of the answer is limited to being associated with a maximum number of attributions. In some embodiments, each of the one or more attributions includes one or more pointers from the portion of the answer to corresponding content in the sources.

As illustrated in FIG. 8, the method 800 also includes an act 810 of presenting the one or more attributions for display. Once the answer and attributions have been generated, they may be presented for display to the user via the user interface. For example, the same UI where the question was entered may thereafter display the answer and attributions.

In some embodiments, the method further includes receiving a second attribution request associated with a second portion of the answer different from the first portion of the answer, generating, by the attribution generator, second one or more attributions for the second portion of the answer based on the sources associated with the answer, and presenting the second one or more attributions for display.

In some embodiments, a method of generating fine-grain attributions in DQA can include receiving a question for a document, generating, by an answer generator, an answer corresponding to the question, generating, by an attribution generator, one or more attributions for a plurality of portions of the answer based on sources associated with the answer, and presenting the answer and the one or more attributions for display. In some embodiments, the method further includes receiving a selection of a first attribution and causing a corresponding portion of the document to be presented for display.

In some embodiments, generating, by an answer generator, an answer corresponding to the question, further includes generating, by a prompt generator, a prompt based on the document and the question, the prompt instructing a document question answering model to answer the question and provide one or more sources for the answer, and generating, by the document question answering model, the answer corresponding to the question, wherein the answer includes the one or more sources for the answer. In some embodiments, the document question answering model is a large language model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 that may be configured to perform one or more of the processes described above. One will appreciate that one or more computing devices such as the computing device 900 may implement the DQA system. As shown by FIG. 9, the computing device can comprise a processor 902, memory 904, one or more communication interfaces 906, a storage device 908, and one or more I/O devices/interfaces 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 908 and decode and execute them. In various embodiments, the processor(s) 902 may include one or more central processing units (CPUs), graphics processing units (GPUs), field programmable gate arrays (FPGAs), systems on chip (SoC), or other processor(s) or combinations of processors.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The computing device 900 can further include one or more communication interfaces 906. A communication interface 906 can include hardware, software, or both. The communication interface 906 can provide one or more interfaces for communication (such as, for example, packet-based communication) between the computing device and one or more other computing devices 900 or one or more networks. As an example and not by way of limitation, communication interface 906 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can comprise hardware, software, or both that couples components of computing device 900 to each other.

The computing device 900 includes a storage device 908 includes storage for storing data or instructions. As an example, and not by way of limitation, storage device 908 can comprise a non-transitory storage medium described above. The storage device 908 may include a hard disk drive (HDD), flash memory, a Universal Serial Bus (USB) drive or a combination of these or other storage devices. The computing device 900 also includes one or more input or output (“I/O”) devices/interfaces 910, which are provided to allow a user to provide input to (such as user strokes), receive output from, and otherwise transfer data to and from the computing device 900. These I/O devices/interfaces 910 may include a mouse, keypad or a keyboard, a touch screen, camera, optical scanner, network interface, modem, other known I/O devices or a combination of such I/O devices/interfaces 910. The touch screen may be activated with a stylus or a finger.

The I/O devices/interfaces 910 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 910 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

1. A method comprising:
receiving a question for a document;
generating, by an answer generator, an answer corresponding to the question;
receiving an attribution request associated with a portion of the answer, wherein the portion of the answer includes a subset of text from the answer;
generating, by an attribution generator, document-answer pairs comprising document embeddings and answer embeddings;
selecting, by the attribution generator, one or more attributions for the portion of the answer based on a similarity between the document-answer pairs; and
presenting the one or more attributions for display.

2. The method of claim 1, wherein generating, by an answer generator, an answer corresponding to the question, further comprises:
providing, to the answer generator, a prompt including the question, wherein the prompt requests inline source citations from the answer generator, and wherein the inline source citations are parsed by the attribution generator for error handling.

3. The method of claim 1, further comprises:
extracting a first one or more fact statements from the portion of the answer;
extracting a second one or more fact statements from sources associated with the answer; and
determining the one or more attributions by matching the first one or more fact statements to one or more fact statements from the second one or more fact statements.

4. The method of claim 1, further comprises:
retrieving, by the attribution generator, one or more portions of sources based on the portion of the answer;
determining, by the attribution generator, a relevance score for each of the one or more portions of the sources; and
generating, by the attribution generator, the one or more attributions based on the one or more portions of the sources and their corresponding relevance scores.

5. The method of claim 4, wherein a relevance score for a second attribution is within a relative threshold difference from a relevance score for a first attribution.

6. The method of claim 5, wherein the portion of the answer is limited to being associated with a maximum number of attributions.

7. The method of claim 1, wherein each of the one or more attributions includes one or more pointers from the portion of the answer to corresponding content in a source.

8. The method of claim 1, further comprising:
receiving a second attribution request associated with a second portion of the answer different from the portion of the answer;
generating, by the attribution generator, second one or more attributions for the second portion of the answer based on sources associated with the answer; and
presenting the second one or more attributions for display.

9. A non-transitory computer-readable medium storing executable instructions, which when executed by a processing device, cause the processing device to perform operations comprising:
receiving a question for a document;
generating, by an answer generator, an answer corresponding to the question;
receiving an attribution request associated with a portion of the answer, wherein the portion of the answer includes a subset of text from the answer;
generating, by an attribution generator, document-answer pairs comprising document embeddings and answer embeddings;
selecting, by the attribution generator, one or more attributions for the portion of the answer based on a similarity between the document-answer pairs; and
presenting the one or more attributions for display.

10. The non-transitory computer-readable medium of claim 9, wherein the operation of generating, by an answer generator, an answer corresponding to the question, further comprises:
providing, to the answer generator, a prompt including the question, wherein the prompt requests inline source citations from the answer generator, wherein the inline source citations are parsed by the attribution generator for error handling.

11. The non-transitory computer-readable medium of claim 9, further comprises:
extracting a first one or more fact statements from the portion of the answer;
extracting a second one or more fact statements from sources associated with the answer; and
determining the one or more attributions by matching the first one or more fact statements to one or more fact statements from the second one or more fact statements.

12. The non-transitory computer-readable medium of claim 9, further comprises:
retrieving, by the attribution generator, one or more portions of sources based on the portion of the answer;
determining, by the attribution generator, a relevance score for each of the one or more portions of the sources; and
generating, by the attribution generator, the one or more attributions based on the one or more portions of the sources and their corresponding relevance scores.

13. The non-transitory computer-readable medium of claim 12, wherein a relevance score for a second attribution is within a relative threshold difference from a relevance score for a first attribution.

14. The non-transitory computer-readable medium of claim 13, wherein the portion of the answer is limited to being associated with a maximum number of attributions.

15. The non-transitory computer-readable medium of claim 9, wherein each of the one or more attributions includes one or more pointers from the portion of the answer to corresponding content in a source.

16. The non-transitory computer-readable medium of claim 9, storing instructions that further cause the processing device to perform operations comprising:
receiving a second attribution request associated with a second portion of the answer different from the portion of the answer;
generating, by the attribution generator, second one or more attributions for the second portion of the answer based on sources associated with the answer; and
presenting the second one or more attributions for display.

17. A system comprising:
a memory component; and
a processing device coupled to the memory component, the processing device to perform operations comprising:
receiving a question for a document;
generating, by an answer generator, an answer corresponding to the question;
generating, by an attribution generator, document-answer pairs comprising document embeddings and answer embeddings;
selecting, by the attribution generator, one or more attributions for a plurality of portions of the answer based on a similarity between the document-answer pairs; and
presenting the answer and the one or more attributions for display.

18. The system of claim 17, wherein the processing device performs further operations comprising:
receiving a selection of a first attribution; and
causing a corresponding portion of the document to be presented for display.

19. The system of claim 17, wherein the operation of generating, by an answer generator, an answer corresponding to the question, further comprises:
generating, by a prompt generator, a prompt based on the document and the question, the prompt instructing a document question answering model to answer the question and provide one or more sources for the answer; and
generating, by the document question answering model, the answer corresponding to the question, wherein the answer includes the one or more sources for the answer.

20. The system of claim 19, wherein the document question answering model is a large language model.
